(19) United States
(12) Patent Application Publication
(10) Pub. No.: US 2026/0307517 A1
(43) Pub. Date: Oct. 8, 2026

(54) MODULAR AND DEPLOYABLE ELECTRIC VEHICLE CHARGING ISLAND SYSTEM AND ASSOCIATED DEVICES AND METHODS

(71) Applicant: PROLOGIS, L.P., San Francisco, CA (US)

(72) Inventors: Lee Martin, San Francisco, CA (US); Casper Jan-Theo Hendrik Steenkamp, San Francisco, CA (US)

(21) Appl. No.: 19/171,132

(22) Filed: Apr. 4, 2025

(51) Int. Cl. B60L 53/31; B60L 53/18; B60L 53/53; B60L 53/60

(52) U.S. Cl. CPC B60L 53/31; B60L 53/18; B60L 53/53; B60L 53/60

(57) ABSTRACT

Electric vehicle (EV) charging island systems and associated devices and methods are disclosed herein. In some embodiments, the system comprises a skid, charging posts, electrical components, a breaker, and a controller. The skid can include a structural frame, anchors that releasably secure the structural frame to a surface, and an accelerometer. The breaker can be configured to selectively cut off power to and/or from the at least one of the electrical components. The controller can be operably coupled to the accelerometer and the breaker. The controller can be configured to (i) receive, from the accelerometer, an accelerometer signal indicating that the skid was impacted by an external object, and (ii) transmit, in response to receiving the accelerometer signal, a breaker control signal to the breaker. The breaker control signal can configure the breaker to cut off power to and/or from the at least one of the plurality of electrical components.

### TECHNICAL FIELD

The present technology generally relates to electric vehicle charging systems, and in particular to modular and deployable electric vehicle charging island systems and associated devices and methods.

### BACKGROUND

As the number of electric vehicles (EVs) continues to increase, the demand for EV charging infrastructure is also expected to increase. Existing EV charging infrastructure typically includes charging stations that are permanently installed at a site. However, installing such charging stations on-site can be labor-intensive and time-consuming. Charging station also typically require sufficient utility power available nearby, which narrows down potential sites for such installation. Charging stations may also require regulatory approval, which can be complex, lengthy, and uncertain. Moreover, many fleet operators who are interested in transitioning to an EV-based fleet may not be willing to commit to a charging station or other permanently installed infrastructure at a site they do not own, may not have a suitable site with sufficient utility power available nearby, or may not have the funds for a full-scale charging station. Therefore, there is a need for an EV charging solution that addresses these challenges by providing a more flexible, efficient, and cost-effective approach to EV charging infrastructure.

### BRIEF DESCRIPTION OF THE DRAWINGS

Features, aspects, and advantages of the presently disclosed technology may be better understood with regard to the following drawings.

FIGS. 1A-1E are perspective, front, rear, right, and left views, respectively, of an electric vehicle (EV) charging island system configured in accordance with embodiments of the present technology.

FIG. 2 is a schematic block diagram illustrating components of a skid included in the EV charging island system of FIGS. 1A-1E and configured in accordance with embodiments of the present technology.

FIG. 3 is a plan view of a structural frame included in the skid and configured in accordance with embodiments of the present technology.

FIGS. 4 and 5 are plan views of cable trays included in the skid and configured in accordance with embodiments of the present technology.

FIG. 6 is an enlarged side cross-sectional view of an anchor included in the skid and configured in accordance with embodiments of the present technology.

FIG. 7 is an enlarged perspective rear view of lighting devices included in the EV charging island system and configured in accordance with embodiments of the present technology.

FIG. 8 is a partially schematic diagram illustrating operation of an accelerometer and a controller each included in the EV charging island system in accordance with embodiments of the present technology.

FIGS. 9A and 9B are top and front views, respectively, of a lifting lug that can be included in the EV charging island system and configured in accordance with embodiments of the present technology.

FIG. 10 is a flowchart illustrating a method for operating a modular and EV charging island system in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present technology are directed to modular and deployable electric vehicle (EV) charging island systems and associated devices and methods. Current EV charging infrastructure generally consists of charging stations that are permanently fixed at specific locations. The process of installing these stations on-site is often laborious and time-consuming. Additionally, these stations typically require a nearby source of adequate utility power, which limits the number of viable installation sites. The regulatory approval process for these stations can also be intricate, protracted, and unpredictable. Furthermore, many fleet operators looking to switch to an EV fleet may be hesitant to invest in permanent charging infrastructure. For example, they may lack access to sites with sufficient utility power or may not have the financial resources for a comprehensive charging station setup.

Embodiments of the present technology address at least some of the above described issues by providing modular and deployable EV charging island systems. For example, embodiments of the present technology include an EV charging island system comprising a skid, a plurality of charging posts, a plurality of electrical components, a breaker, and a controller. The skid can include a structural frame, a plurality of anchors coupled to the structural frame and configured to releasably secure the structural frame to a surface, and an accelerometer mounted on the structural frame. Each of the plurality of charging posts, the plurality of electrical components, and the breaker can be mounted on the skid. Each of the plurality of electrical components can also be electrically coupled to the plurality of charging posts. The breaker can be operably coupled to at least one of the plurality of electrical components. The breaker can be configured to selectively cut off power to and/or from the at least one of the plurality of electrical components. The controller can be operably coupled to the accelerometer and the breaker. The controller can be configured to (i) receive, from the accelerometer, an accelerometer signal indicating that the skid was impacted by an external object, and (ii) transmit, in response to receiving the accelerometer signal, a breaker control signal to the breaker. The breaker control signal can configure the breaker to cut off power to and/or from the at least one of the plurality of electrical components.

Embodiments of the present technology can also include a method for operating a modular and deployable EV charging island system. The method can comprise (i) receiving an accelerometer signal from an accelerometer of the EV charging island system. The EV charging island system can comprise a skid, a plurality of electrical components, and a breaker. The skid can include a structural frame, a plurality of anchors configured to releasably secure the structural frame to a surface, and the accelerometer mounted on the structural frame. The accelerometer signal can indicate that the skid was impacted by an external object. Each of the plurality of electrical components and the breaker can be mounted on the skid. The breaker can be operably coupled to at least one of the plurality of electrical components, and can be configured to selectively cut off power to and/or from the at least one of the plurality of electrical components. The method can also comprise transmitting, in response to receiving the accelerometer signal, a breaker control signal to the breaker. The breaker control signal can configure the breaker to cut off power to and/or from the at least one of the plurality of electrical components.

Embodiments of the present technology enable several advantages over many existing EV charging infrastructure. First, because most of the EV charging island system can be manufactured and assembled off-site, installing the EV charging island system can require significantly less time and labor on-site. Second, because many factors can be more precisely controlled off-site than on-site, prefabrication is also expected to reduce both safety risks and manufacturing errors. Third, because many components of the EV charging island system can be integrated and assembled together before installation, the EV charging island system may be UL-listed, thereby reducing the complexities, time, and costs associated with regulatory approval typically required for many existing EV charging infrastructure (e.g., permanently installed charging stations). Fourth, because all of the components can either be mounted on or integrated with a skid, the EV charging island system can be both portable and temporary. For example, the EV charging island system can be trailer-mounted. Fifth, the components included can be customized for specific applications, resulting in a modular EV charging solution. Sixth, because the EV charging island system itself can include generator sets, batteries, and/or the like, the EV charging island system can be installed at sites removed from a sufficient utility power supply. Seventh, the EV charging island system includes an accelerometer-based safety feature that can cut off power at multiple levels (e.g., cut off power to EVs, within the system, and to the system) upon detecting a collision with an EV or other impact by an external object.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Select Embodiments of an EV Charging Island System

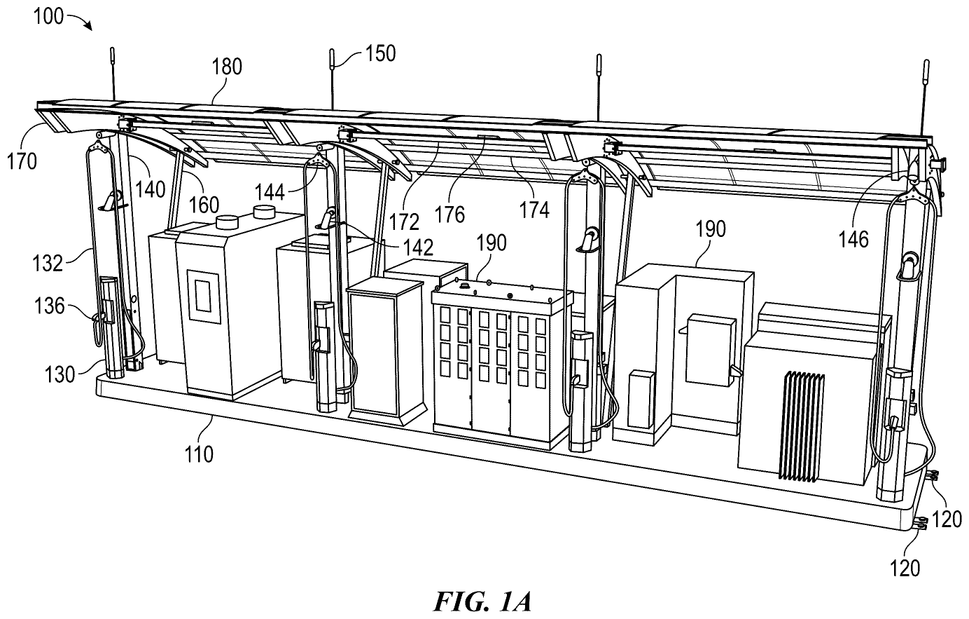

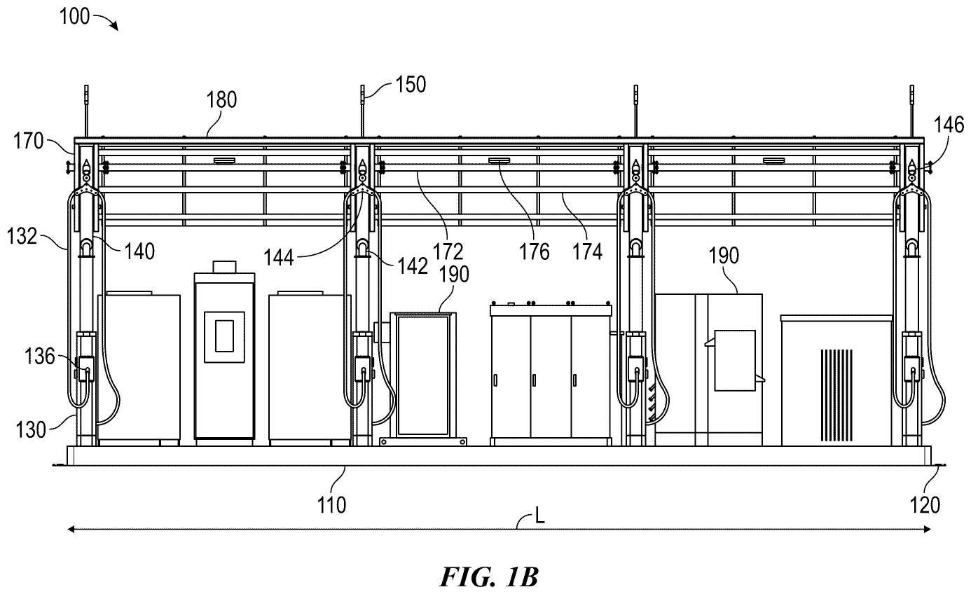

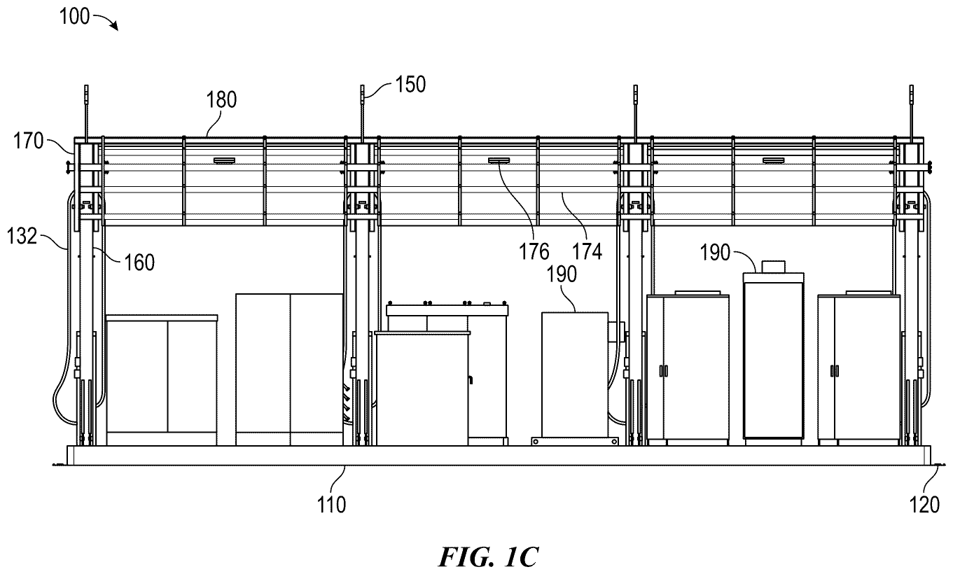

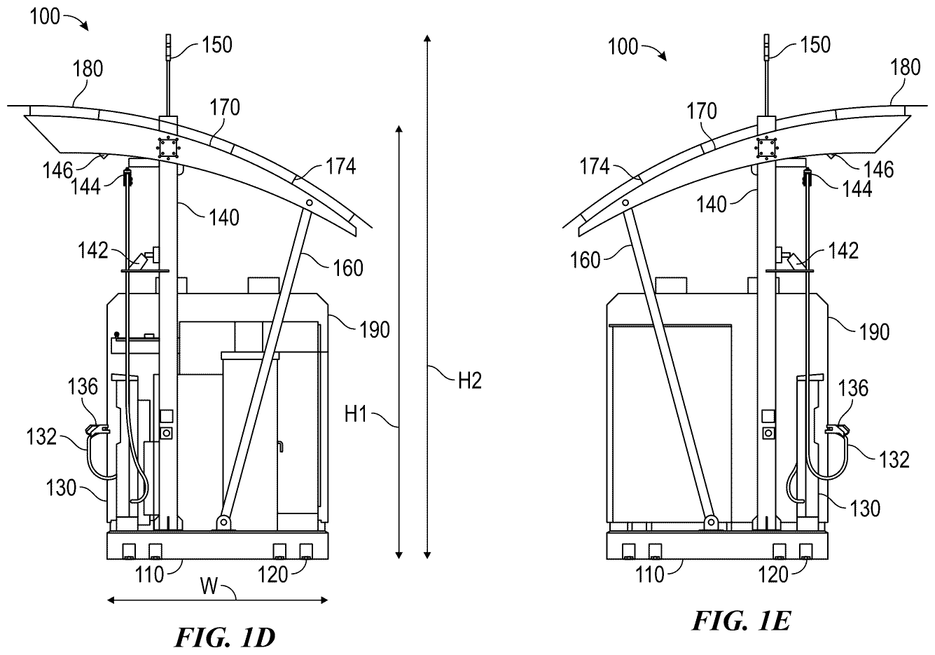

FIGS. 1A-1E are perspective, front, rear, right, and left views, respectively, of an electric vehicle (EV) charging island system 100 (“the system 100”) configured in accordance with embodiments of the present technology. Referring to FIGS. 1A-1E together, the system 100 can include a skid 110, a plurality of charging posts 130, a plurality of smart posts 140, a plurality of support struts 160, a canopy 180, and a plurality of electrical components 190.

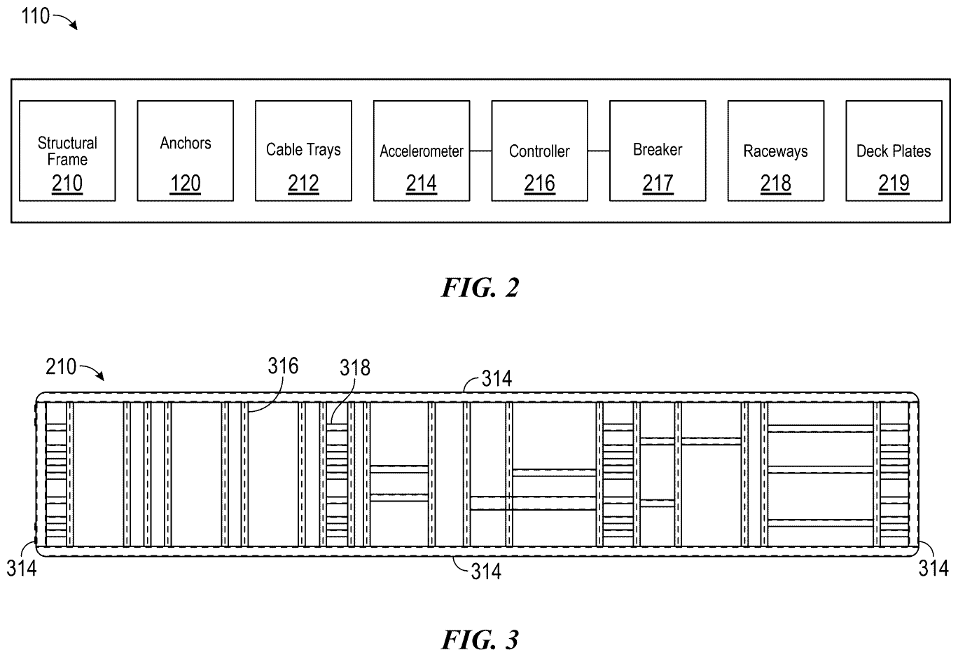

The skid 110 can have a generally flat form factor and can serve as a platform for the other components of the system 100. In the illustrated embodiment, the skid 110 has a generally rectangular shape with rounded corners. The skid 110 can have a length L (FIG. 1B) between about 400-600 inches (e.g., 516 inches) and a width W (FIG. 1D) between about 80-120 inches (e.g., 96 inches). The skid 110 can also include a plurality of anchors 120 that can releasably secure the skid 110 (and thus the entire system 100) onto a surface, such as metal, cement, or other substrate on-site. In the illustrated embodiment and as best seen in FIGS. 1D and 1E, the skid 110 includes four pairs of anchors 120, each pair positioned along either the left or right sidewall of the skid 110 and adjacent to either the front or rear wall of the skid 110. Additional details regarding the skid 110 are discussed below with reference to FIGS. 2-6.

The plurality of charging posts 130 can each be mounted on the skid 110. In particular, in the illustrated embodiment, a first charging post 130 is mounted on the front-left corner of the skid 110, a second charging post 130 is mounted on the front-right corner of the skid 110, a third charging post 130 is positioned between the first and second charging posts 130, and a fourth charging post 130 is positioned between the second and third charging posts 130. In some embodiments, adjacent charging posts 130 are spaced apart equally. Each charging post 130 can include a charging cable 132 and a connector 136 that a user can connect to an electric vehicle (EV) to charge the EV.

The plurality of smart posts 140 can each be mounted on the skid 110. In particular, in the illustrated embodiment, a first smart post 140 is positioned adjacent to and rear of the first charging post 130, a second smart post 140 is positioned adjacent to and rear of the second charging post 130, a third smart post 140 is positioned adjacent to and rear of the third charging post 130, and a fourth smart post 140 is positioned adjacent to and rear of the fourth charging post 130. As illustrated in FIGS. 1A-1E, the plurality of smart posts 140 can each include a vertical column and can together support the canopy 180 thereon. In some embodiments, each smart post 140 also includes a camera 142, a cable guide assembly 144, a light source 146, and an indicator 150, each mounted on the vertical column. The camera 142 can be positioned above the corresponding charging post 130 and oriented to face the area forward of the corresponding charging post 130. Therefore, the cameras 142 can capture, e.g., the EVs and/or personnel using the system 100. Each cable guide assembly 144 can be positioned above the corresponding camera 142 and can support (e.g., suspend) the charging cable 132 of the corresponding charging post 130. Each light source 146 can be positioned above the corresponding cable guide assembly 144 and can be oriented to illuminate the area forward of the corresponding charging post 130. Each indicator 150 can extend upward from the vertical column and above the canopy 180.

The plurality of support struts 160 can each be mounted on the skid 110. In particular, in the illustrated embodiment, a first support strut 160 is positioned adjacent to and rear of the first smart post 140, a second support strut 160 is positioned adjacent to and rear of the second smart post 140, a third support strut 160 is positioned adjacent to and rear of the third smart post 140, and a fourth support strut 160 is positioned adjacent to and rear of the fourth smart post 140. As illustrated in FIGS. 1A-1E, the plurality of support struts 160 can each extend upward from the skid 110 at a rearward angle. Each pair of a smart post 140 and a support strut 160 can support a pair of a plurality of arched beams 170.

The canopy 180 can be mounted on the plurality of arched beams 170. More specifically, the system 100 can further include a plurality of canopy support beams 174 each coupled to upper surfaces of the plurality of arched beams 170 and extending laterally thereacross. As illustrated in FIGS. 1D and 1E, different ones of the plurality of canopy support beams 174 (e.g., I-beams) can be coupled to different points along the curvature of the arched beams 170. The canopy 180 can be mounted on the plurality of canopy support beams 174. As best seen in FIGS. 1D and 1E, the canopy 180 can have a curvature corresponding to the curvature of the plurality of arched beams 170 such that, e.g., a front portion of the canopy 180 is substantially horizontal and a rear portion of the canopy 180 is angled. In some embodiments, the canopy 180 includes solar panels that can, e.g., power or charge one or more of the electrical components 190. In some embodiments, the system 100 omits the canopy 180.

Referring to FIG. 1D, the system 100 can have a first height H1 excluding the indicators 150 (e.g., up to the highest portion of the canopy 180) and a second height H2 including the indicators 150. The first height H1 can be between about 160-220 inches (e.g., 193 inches). The second height H2 can be between about 180-250 inches (e.g., 227 inches). It is appreciated that the given ranges of the length L, the width W, the first height H1, and the second height H2 are merely illustrative example ranges, and that each dimension can be smaller or greater than the given ranges.

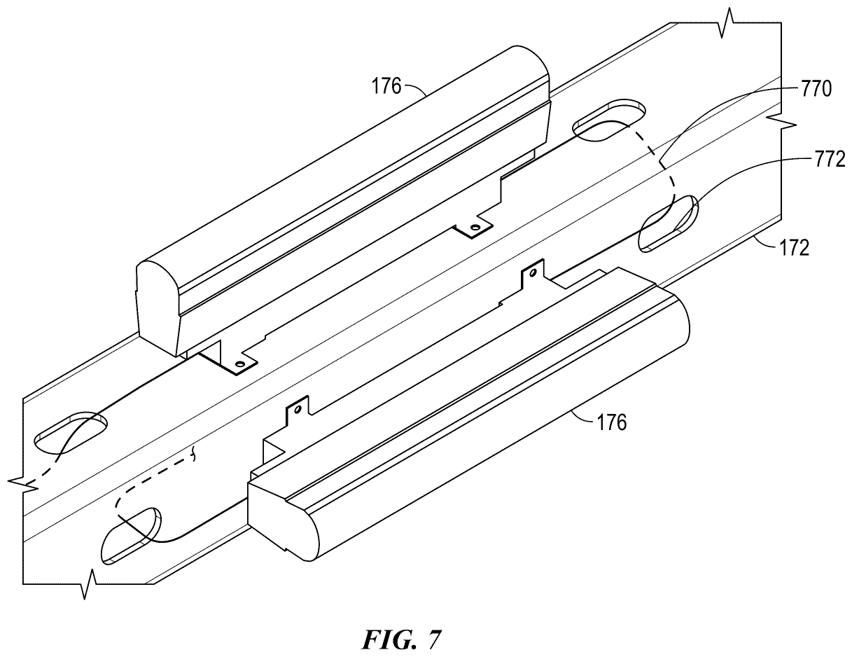

The system can further include a plurality of horizontal beams 172 and a plurality of lighting devices 176. Each horizontal beam 172 can extend between adjacent pairs of the plurality of arched beams 170 and below the canopy 180. The plurality of lighting devices 176 can each be mounted on one of the horizontal beams 172. One, two, or more lighting devices 176 can be mounted on each horizontal beam 172. The lighting devices 176 can be oriented to illuminate a lower surface (e.g., an underside) of the canopy 180. In some embodiments, the canopy 180 is composed of polycarbonate or other transparent/translucent material such that the canopy 180 can both (i) allow sunlight to pass through and (ii) reflect the light emitted by the plurality of lighting devices 176 to indirectly illuminate the area below the canopy 180. Additional details regarding the plurality of lighting devices 176 are discussed below with reference to FIG. 7.

The plurality of electrical components 190 can each be mounted on the skid 110 and can include one or more types of devices suitable for delivering charge to EVs connected to the charging cables 132 and the connectors 136. For example, the plurality of electrical components 190 can include at least one, two, three, four, or more of the following: a generator set, a battery, a transformer, a converter, a splitter, an inverter, a network box, a switchgear, and/or the like. It is appreciated that the specific electrical components to be included in the system 100 can be customized for the specific application. For example, if the system 100 is to be connected to a power grid such that EVs can be charged via utility power, one or more transformers can be included among the plurality of electrical components 190. If the system 100 is to be connected to a power grid and capable of generating and storing energy, one or more transformers, one or more generator sets, and one or more batteries can be included among the plurality of electrical components 190. The batteries can be recharged by the power grid, the generator sets, and/or other external chargers, such as a charging vehicle that stops by the system 100 routinely or on demand. If the system 100 is not to be connected to a power grid (e.g., due to the location of the installation site), one or more generator sets and/or one or more batteries can be included among the plurality of electrical components 190 (e.g., without a transformer). In some embodiments, the arrangement of the plurality of electrical components 190 can be selected to evenly distribute the weights thereof on the skid 110.

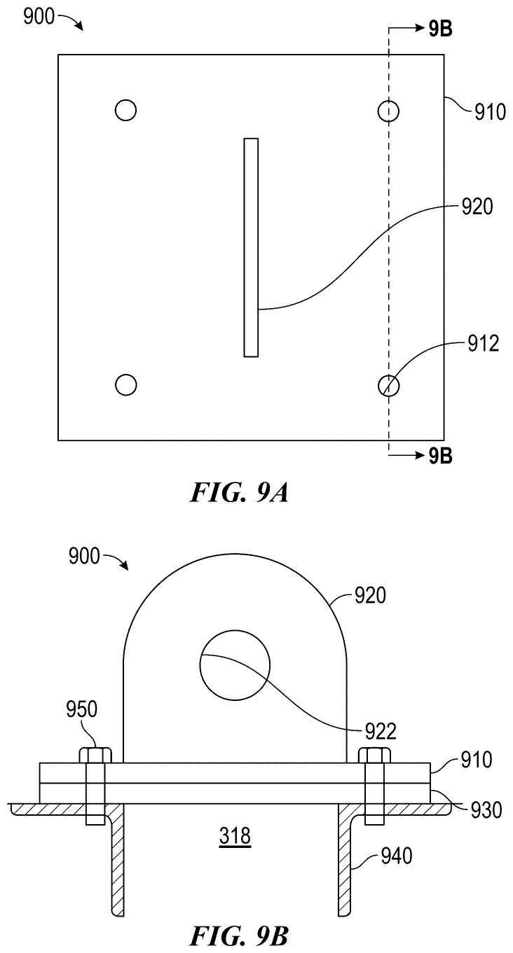

In some embodiments, the system 100 further includes a plurality of lifting lugs (not shown in FIGS. 1A-1E). The lifting lugs can be permanently or removably mounted on the skid 110, and can facilitate handling of the system 100 during, e.g., installation of the skid 110 onto a surface. Additional details regarding the plurality of lifting lugs are discussed below with reference to FIGS. 9A and 9B.

It is appreciated that the illustrated embodiment of the system 100 in FIGS. 1A-1E is merely one example, and that various features of the system 100 can be modified within the scope of the present technology. For example, (i) the skid 110 can include a different number and/or arrangement of the anchors 120, (ii) the skid 110 can have different shapes and/or dimensions, (iii) the system 100 can include a different number of charging posts 130, smart posts 140, and/or support struts 160, (iv) the canopy 180 can have a different shape and/or size, (v) the plurality of electrical components 190 can vary, and/or the like. Additionally or alternatively, one or more components (e.g., the plurality of lighting devices 176) can be omitted from and/or additional components not shown (e.g., cables extending through the skid 110) can be included in the system 100.

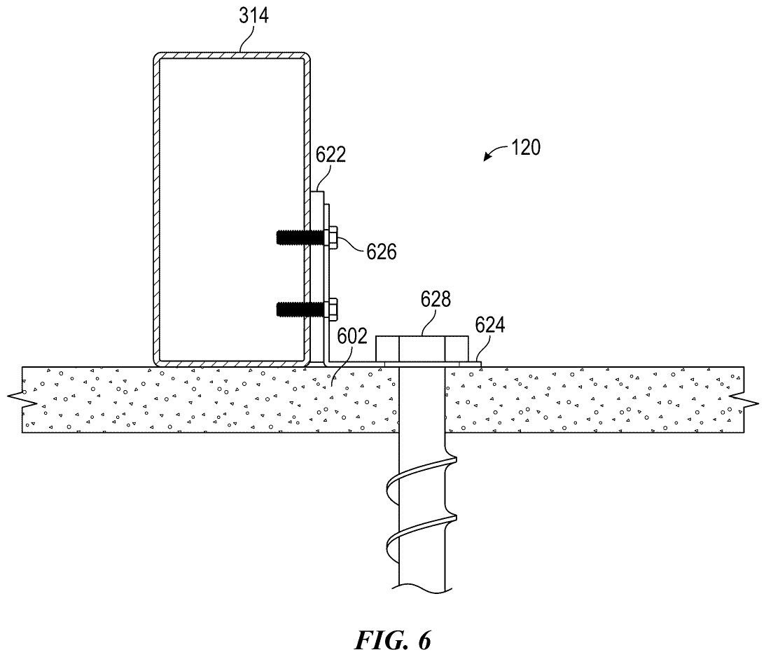

FIG. 2 is a schematic block diagram illustrating components of the skid 110 configured in accordance with embodiments of the present technology. As shown, the skid 110 can include a structural frame 210, the plurality of anchors 120 (FIGS. 1A-1E), one or more cable trays 212, an accelerometer 214, a controller 216, a breaker 217 (also referred to as “the main breaker 217”), one or more raceways 218, and one or more deck plates 219. The structural frame 210 can serve as the base structure that other components of the skid 110 can be mounted on. Additional details regarding the structural frame 210 are discussed below with reference to FIG. 3. In some embodiments, the anchors 120 are coupled to the structural frame 210, and can releasably secure the structural frame 210 to a surface (e.g., on-site). Additional details regarding the anchors 120 are discussed below with reference to FIG. 6.

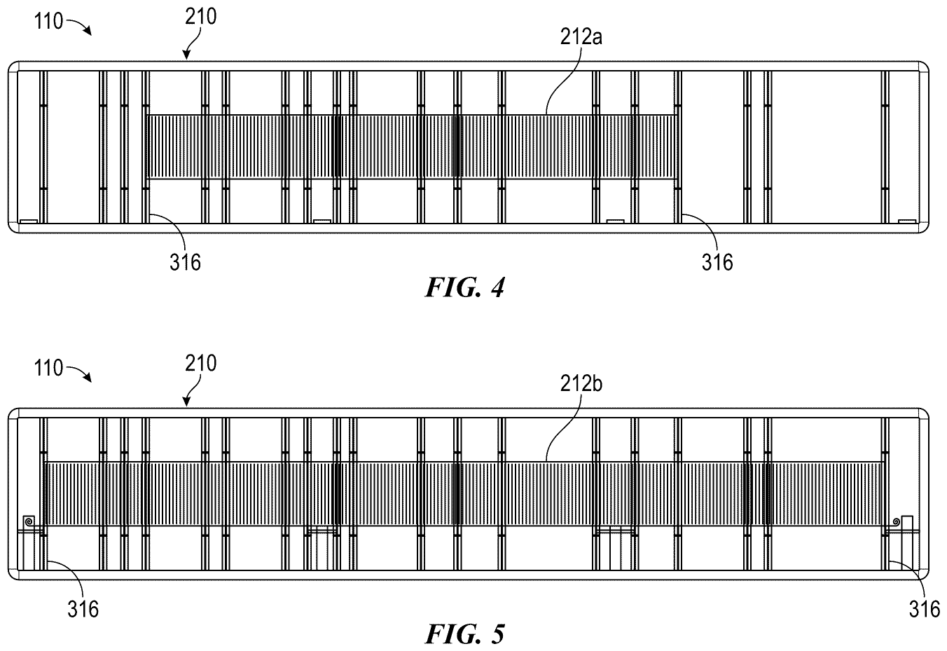

The one or more cable trays 212 can be mounted on the structural frame 210. The one or more cable trays 212 can each support one or more cables extending through the skid 110. For example, the system 100 can include cables electrically connecting the plurality of electrical components 190 (including with one another, such as a cable connecting a generator set to a battery), the plurality of charging posts 130, and/or the plurality of smart posts 140. The one or more cable trays 212 can be composed of metal (e.g., aluminum), plastic, or other suitable materials. Additional details regarding the one or more cable trays 212 are discussed below with reference to FIGS. 4 and 5.

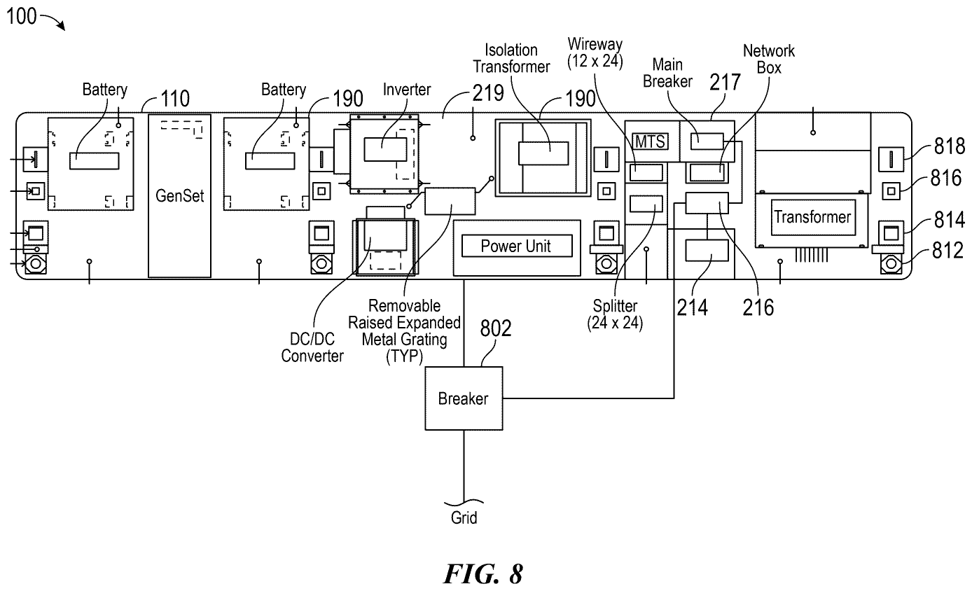

The controller 216 can be operably coupled to each of the accelerometer 214 and the breaker 217. The accelerometer 214, the controller 216, and/or the breaker 217 can each be mounted on the structural frame 210 or other component of the skid 110. Also, while illustrated as part of the skid 110 in FIG. 2, in some embodiments, the accelerometer 214, the controller 216, and/or the breaker 217 can be positioned elsewhere, such as on top of the skid 110 and/or coupled to one or more of the electrical components 190. The accelerometer 214 can measure any acceleration experienced by the system 100 (e.g., due to an EV colliding with the skid 110). The breaker 217 can selectively cut off power to and/or from the at least one of the plurality of electrical components 190, the charging posts 130, and/or the smart posts 140. Additional details regarding the accelerometer 214, the controller 216, and the breaker 217 are discussed below with reference to FIG. 8.

The one or more raceways 218 can safeguard the cables extending through the skid 110 from physical damage, moisture, and other environmental factors. The one or more raceways 218 can be positioned along the one or more cable trays 212 and/or extend between the one or more cable trays 212 and the components that the cables are electrically connected to (e.g., the charging posts 130, the smart posts 140, the electrical components 190). The one or more deck plates 219 can include metal, plastic, ceramic, or other suitable materials, and can be coupled (e.g., via fasteners) to the top of the structural frame 210 and serve as a top cover of the skid 110. Therefore, the one or more deck plates 219 can provide a generally flat surface on which other components of the system 100 can be mounted on. The one or more deck plates 219 can include holes and/or may not fully cover the top of the structural frame 210 to leave gaps so that cables can be extended therethrough.

FIG. 3 is a plan view of the structural frame 210 configured in accordance with embodiments of the present technology. The structural frame 210 can include a plurality of beams including a plurality of perimeter beams 314, a plurality of widthwise beams 316, and a plurality of crossbeams 318. The plurality of perimeter beams 314 can extend along and define a perimeter of the structural frame 210. In the illustrated embodiment, the structural frame 210 includes four perimeter beams 314, each extending along the front, rear, left, or right edge of the skid 110. Select ones of the perimeter beams 314 can be formed to have rounded ends, as shown in FIG. 3, to provide the rounded corners of the skid 110, as shown in FIG. 1A.

The plurality of widthwise beams 316 can each extend between the front and rear perimeter beams 314 at varying intervals. The plurality of crossbeams 318 can each extend between select ones of the widthwise beams 316 at varying intervals. It is appreciated that the specific arrangement of the widthwise beams 316 and the crossbeams 318 can vary depending on various factors. For example, the arrangement of the electrical components 190 may be determined first, then the arrangement of the widthwise beams 316 and the crossbeams 318 can determined based on the arrangement of the electrical components 190, such as to ensure that the widthwise beams 316 and the crossbeams 318 are not in the way of any cables extending from the electrical components 190. In another example, the number and arrangement of the charging posts 130, the smart posts 140, and the support struts 160 may be determined first, then the arrangement of the widthwise beams 316 and the crossbeams 318 can determined based on the arrangement of the charging posts 130, the smart posts 140, and the support struts 160, such as to ensure that the widthwise beams 316 and the crossbeams 318 are positioned to properly support the weights thereof without getting in the way of any cables extending therefrom.

Individual ones of the plurality of perimeter beams 314, the plurality of widthwise beams 316, and/or the plurality of crossbeams 318 can include hollow structural sections (HSS), I-beams, and/or the like. The plurality of beams can be composed of metal (e.g., structural steel) or other suitable materials. The plurality of beams can be coupled to one another via welding, fasteners, and/or other suitable coupling mechanisms. The plurality of beams can be arranged parallel and/or perpendicular to one another, as shown in FIG. 3, or at non-90 degree angles.

FIGS. 4 and 5 are plan views of the cable trays 212 configured in accordance with embodiments of the present technology. More specifically, FIG. 4 illustrates a first cable tray 212a and FIG. 5 illustrates a second cable tray 212b. Multiple cable trays 212 may be needed to support the number of cables extending through the skid 110 (e.g., there may be too many cables to be supported by a single cable tray 212). In some embodiments, the first cable tray 212a can be positioned at a first height and the second cable tray 212b can be positioned at a second height higher or lower than the first height. Thus, the first and second cable trays 212a, 212b can be arranged in a vertically overlapping manner. As an example, the first cable tray 212a can support cables extending between a power grid and a transformer included in the electrical components 190, and the second cable tray 212b can support cables extending between the transfer and other components of the system 100 (e.g., other electrical components 190, the charging posts 130, the smart posts 140).

Referring to FIGS. 4 and 5 together, each of the cable trays 212 can be mounted on select ones of the widthwise beams 316. In particular, each of the first cable tray 212a and the second cable tray 212b has a length such that the ends of each cable tray 212 are aligned along the widthwise beams 316 that are labeled in FIGS. 4 and 5, respectively. However, it is appreciated that the lengths of the cable trays 212 can be selected based on the specific application as needed. The cable trays 212 can be fixed in position or movable relative to the structural frame 210 (e.g., slide out for easier access).

In some embodiments, the system 100 includes a plurality of diesel locomotive cables that extend from the plurality of electrical components 190, the plurality of charging posts 130, and/or the plurality of smart posts 140. Diesel locomotive cables are cables are designed to be highly durable and reliable, capable of withstanding harsh environmental conditions, including extreme temperatures, vibrations, and mechanical stresses, which are common in outdoor and high-traffic areas. For example, the cables can include insulative coating. Diesel locomotive cables also exhibit excellent electrical performance, ensuring efficient power transmission for fast and reliable charging of EVs. Diesel locomotive cables can also be made with fire-resistant and/or low-smoke materials, reducing the risk of fire hazards and enhancing the safety of users and the surrounding environment. Diesel locomotive cables are also highly flexible, thereby not only facilitating installation and maintenance, but also allowing the footprint of the skid 110 and the arrangement of the electrical components 190 to be smaller compared to embodiments employing less flexible cables (e.g., because the cables can be coiled or bent more tightly).

FIG. 6 is an enlarged side cross-sectional view of one of the plurality of anchors 120 configured in accordance with embodiments of the present technology. The anchor 120 can include a repad 622, an L-bracket 624, one or more first fasteners 626, and a second fastener 628. To secure the structural frame 210 (and thus the rest of the system 100) to a surface or substrate 602 (e.g., cement, metal, or other material at the installation location), an operator can (i) position the repad 622 between one of the perimeter beams 314 (e.g., a perimeter beam 314 along the left or right edge of the skid 110) and a first flange of the L-bracket 624, (ii) couple the L-bracket 624 to the perimeter beam 314 via the one or more first fasteners 626 (each of the repad 622 and the first flange of the L-bracket 624 can include corresponding apertures), and (iii) couple a second flange of the L-bracket 624 to the substrate 602 via the second fastener 628. As previously mentioned, the number of anchors 120 can be selected depending on specific application. Also, it is appreciated that the illustrated embodiment of the anchor 120 is merely one example, and that other mechanisms to releasably couple the structural frame 210 to the substrate 610 are within the scope of the present technology.

Because the plurality of anchors 120 releasably secure the system 100 to the substrate 602, unlike charging stations or other permanent infrastructure, the entire system 100 can be uninstalled from the installation site as needed (e.g., by removing the first and second fasteners 626, 628). Therefore, the system 100 is expected to appeal to, e.g., fleet operators who may want to transition to an EV fleet but are unwilling to commit to permanent EV charging infrastructure. Furthermore, by including the plurality of anchors 120 as part of the skid 110, the on-site time and labor required for installation can be reduced compared to installation of many existing EV charging infrastructure. As previously mentioned, most of the system 100 can be prefabricated off-site, and once transported to the on-site location, operators merely need to use the plurality of anchors 120 to secure the entire system 100 to the substrate 602. This contrasts with many existing EV charging infrastructure in which, e.g., individual charging posts and other electrical components need to be anchored individually.

FIG. 7 is an enlarged perspective rear view of the lighting devices 176 configured in accordance with embodiments of the present technology. In particular, FIG. 7 illustrates a portion of a single horizontal beam 172 and a pair of lighting devices 176 mounted thereon. Therefore, in an embodiment of the system 100 including three horizontal beams 172 (e.g., as shown in FIG. 1A), the system 100 can include a total of six lighting devices 176. As shown in FIG. 7, the horizontal beam 172 can have a generally rectangular cross-section, a first lighting device 176 can be mounted on an upper side of the horizontal beam 172, and a second lighting device 176 can be mounted on a rear side of the horizontal beam 172. The lighting devices 176 can be mounted on the horizontal beam via fasteners and/or other suitable coupling mechanisms. Each of the lighting devices 176 can be electrically coupled to a power source (e.g., a battery included among the electrical components 190) via one or more wires 770. The horizontal beam 172 can be hollow and can include one or more holes 772 for the wires 770 to extend therethrough. Therefore, the wires 770 can extend across the system 100 inside the horizontal beams 172 (e.g., for protection from damage and environmental factors) and extend out through the holes 772 to connect to the lighting devices 176.

In the illustrated embodiment, because the canopy 180 is both positioned above the horizontal beam 172 and curves downward toward the rear of the system 100 (see FIGS. 1A-1E), both the first and second lighting devices 176 are oriented to face the lower surface (e.g., the underside) of the canopy 180. Therefore, the canopy 180 can disperse or otherwise reflect the light emitted by both the first and second lighting devices 176 to indirectly illuminate the area below. As previously mentioned, the canopy 180 can be composed of a transparent/translucent material such that in some embodiments, the lighting devices 176 create a visual effect that causes the canopy 180 to appear to be glowing.

FIG. 8 is a partially schematic diagram illustrating operation of the accelerometer 214 and the controller 216 in accordance with embodiments of the present technology. As shown, the system 100 includes the skid 110, the plurality of electrical components 190 and the main breaker 217 each mounted on the deck plates 219 of the skid 110, the accelerometer 214, the controller 216, and connection plates or zones 812, 814, 816, 818. The skid 110 can also include a grating that allows access to the space therein (e.g., for maintenance or rewiring) and/or for ventilation.

The plurality of electrical components 190 can include one or more batteries, inverters, converters (e.g., DC/DC converters), generator sets, power units, transformers, wireways, switchgears, network boxes, and splitters. It is appreciated that the illustrated embodiment is merely one example combination of electrical components 190, and that the system 100 can include fewer, additional, and/or alternative electrical components. In some embodiments, one or more of the electrical components 190 (e.g., a transformer) can be connected to a power grid via an upstream breaker 802. The controller 216 can be operably coupled to each of the accelerometer 214, the main breaker 217, and the upstream breaker 802. The arrangement, spacing, wiring, and/or the like of the electrical component 190 (and of the charging posts 130, the smart posts 140, etc.) can be selected to comply with the National Electric Code (NEC) or other applicable standard.

In the illustrated embodiment, the system 100 includes four sets of each of the connection zones 812, 814, 816, 818, and the plurality of electrical components 190 are arranged on the skid 110 between the sets of connection zones 812, 814, 816, 818 (e.g., mounted on the remaining area of the skid 110). The connection plates or zones 812, 814, 816, 818 can serve as coupling points for other components of the system 100. More specifically, the plurality of charging posts 130 can be mounted on the skid 110 at corresponding ones of the connection zones 812, the plurality of smart posts 140 can be mounted on the skid 110 at corresponding ones of the connection zones 814, the plurality of support struts 160 can be mounted on the skid 110 at corresponding ones of the connection zones 816, and a plurality of lifting lugs (described in further detail below with reference to FIGS. 9A and 9B) can be mounted on the skid 110 at corresponding ones of the connection zones 818. In some embodiments, the connection zones 814 can also serve as connection points for additional lifting lugs. For example, referring to the embodiment shown in FIG. 8, a total of eight lifting lugs can be coupled to the four connection zones 814 and the four connection zones 818 during installation of the skid 110, and once the skid 110 is installed (e.g., via the plurality of anchors 120), the lifting lugs coupled to the four connection zones 814 can be removed and replaced with the smart posts 140. In some embodiments, one or more of the crossbeams 318 of the structural frame 210 are positioned beneath or near each of the connection zones 812, 814, 816, 818 to facilitate coupling of the lifting lugs, the charging posts 130, the smart posts 140, and the support struts 160 and to support the weights thereof.

During operation of the system 100, an external object may accidentally collide with the system 100. For example, the skid 110 or other component of the system 100 may be impacted by an electric truck driven by a careless driver. In such cases, the accelerometer 214 can detect said collision and send an accelerometer signal to the controller 216. For example, the accelerometer 214 and/or the controller 216 can detect that a collision occurred based on the acceleration measured by the accelerometer 214 exceeding a threshold value, based on the acceleration measured exhibiting a certain pattern typically associated with collisions, and/or the like. In some embodiments, the accelerometer 214, the controller 216, the threshold value, and/or other parameters can be tuned for the specific on-site location during installation. It is appreciated that while other types of sensors can be used to detect such collisions, the accelerometer 214 may be preferred. For example, given the size, weight, and anchoring of the system 100, the system 100 may not sufficiently tilt even if impacted by an external object for a tilt sensor to reliably detect such collisions.

Once the controller 216 receives the accelerometer signal from the accelerometer 214, in response, the controller 216 can transmit a breaker control signal to the main breaker 217. The breaker control signal can configure the breaker 217 to cut off power to and/or from the at least one of the plurality of electrical components 190, the plurality of charging posts 130, and/or the plurality of smart posts 140. In other words, the controller 216 can cause the main breaker 217 to cut off power flow within the system 100. Doing so can also cut off power to any EVs that were charging using the system 100 (e.g., coupled to the connectors 136) when the collision occurred. Additionally or alternatively, the controller 216 can, in response to receiving the accelerometer signal from the accelerometer 214, transmit an upstream breaker control signal to the upstream breaker 802. The upstream breaker control signal can configure the upstream breaker 802 to cut off power from the power grid to the system 100. Therefore, in embodiments in which the controller 216 sends signals to both the main breaker 217 and the upstream breaker 802, the system 100 employs a dual-layered safety check to ensure that power is cut off to and within the system 100.

Cutting off power in the case of a collision can be important for several reasons. Primarily, this safety feature helps to prevent electrical fires and other hazards that could arise from damaged charging equipment, thereby protecting both the infrastructure and the surrounding environment. Additionally, damage from the collision can expose live wires, and cutting off power minimizes the risk of electrical shock to individuals who might be nearby during the incident. This automatic power cutoff also aids in reducing the potential for further damage to the system 100 and the EV involved, potentially lowering repair costs and downtime. Furthermore, this feature enhances overall safety and reliability, in turn increasing user confidence in the system 100 and promoting the adoption of EVs.

FIGS. 9A and 9B are top and front views, respectively, of a lifting lug 900 that can be included in the system 100 and configured in accordance with embodiments of the present technology. In particular, FIG. 9A illustrates the lifting lug 900, and FIG. 9B illustrates the lifting lug 900 coupled to one of the crossbeams 318. Referring to FIGS. 9A and 9B together, the lifting lug 900 can include a base plate 910 and a head 920 coupled to a center of the base plate 910 and extending in a perpendicular direction therefrom. The base plate 910 can have a generally flat, rectangular shape and can include a plurality of apertures 912 (four are shown in FIG. 9A). The head 920 can have a generally flat, rounded shape and can include an aperture 922.

Referring to FIG. 9B, to be attached to the crossbeam 318, a pair of L-brackets 940 can be positioned on either side of the crossbeam 318 and a support plate 930 can be positioned between (i) the base plate 910 and (ii) the crossbeam 318 and the L-brackets 940. Thereafter, fasteners 950 (e.g., bolts) can be inserted into the apertures 912 of the base plate 910 and corresponding apertures in the L-brackets 940. The aperture 922 of the head 920 can be sized to receive a hook, a rope, or other grasping feature that facilitates handling (e.g., lifting) of the lifting lug 900, and thus the skid 110 coupled thereto. As previously mentioned, the lifting lug 900 can be removably coupled to the skid 110 at the connection zones 814, 818.

### III. Select Embodiments of a Method for Operating an EV Charging Island System

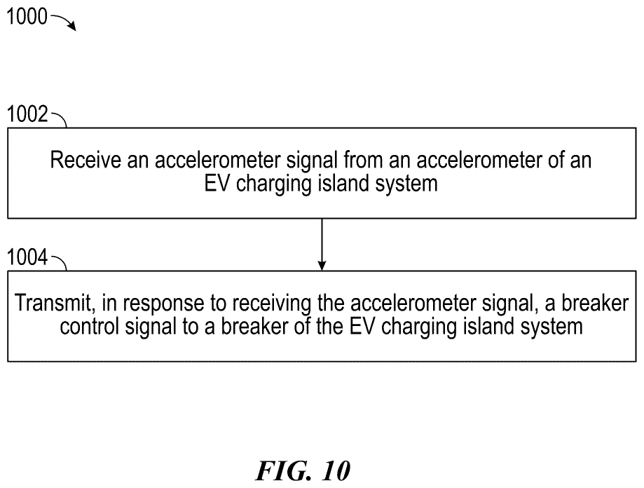

FIG. 10 is a flowchart illustrating a method 1000 for operating a modular and deployable electric vehicle (EV) charging island system in accordance with embodiments of the present technology. While the steps of the method 1000 are described below in a particular order, one or more of the steps can be performed in a different order or omitted, and the method 1000 can include additional and/or alternative steps. Additionally, although the method 1000 may be described below with reference to the embodiments of the present technology described herein, the method 1000 can be performed with other embodiments of the present technology.

The method 1000 begins at block 1002 by receiving an accelerometer signal from an accelerometer of the EV charging island system. The EV charging island system can include a skid, a plurality of electrical components, and a breaker. The skid can include a structural frame, a plurality of anchors configured to releasably secure the structural frame to a surface, and the accelerometer mounted on the structural frame. The accelerometer signal can indicate that the skid was impacted by an external object (e.g., an EV). The accelerometer signal can be received via a wired or wireless connection. Each of the plurality of electrical components and the breaker can be mounted on the skid. The breaker can be operably coupled to at least one of the plurality of electrical components, and can be configured to selectively cut off power to and/or from the at least one of the plurality of electrical components.

In some embodiments, the accelerometer signal indicates that the skid was impacted by an external object based on the measured acceleration meeting one or more conditions. For example, the measured acceleration can be compared against a threshold value or range. If the measured acceleration exceeds the threshold value, this can indicate that the skid was likely impacted by an external object. On the other hand, if the measured acceleration does not exceed the threshold value, this can indicate that the vibration or movement of the skid is minor/negligible and not a cause for concern (e.g., even if the skid was indeed impacted by an external object, the acceleration may be small enough to safely assume that there are no exposed live wires or meaningful damage to the system). The threshold value can be selected based on expected measured accelerations and may also account for error margins. A relatively high threshold value can reduce the likelihood of false positives, while a relatively low threshold value can increase the overall safety level.

Moreover, in some embodiments, the accelerometer selectively transmits the accelerometer signal if the measured acceleration meets the one or more conditions. For example, the accelerometer may transmit the accelerometer signal (e.g., to the controller 216) only if the measured acceleration exceeds the threshold value. In other embodiments, the accelerometer continuously or regularly transmits the measured acceleration, and the “accelerometer signal” corresponds to a measured acceleration that exceeds the threshold value as determined by, e.g., a controller. In other words, the determination of whether the measured acceleration indicates that the skid was impacted by an external object can be made by the accelerometer and/or the controller.

At block 1004, the method 1000 continues by transmitting, in response to receiving the accelerometer signal, a breaker control signal to the breaker. The breaker control signal can configure the breaker to cut off power to and/or from the at least one of the plurality of electrical components and/or other components of the EV charging island system, such as the charging posts 130 or the smart posts 140. By selectively cutting off power within the EV charging island system when the EV charging island system is impacted by an external object (e.g., as determined by the accelerometer and/or the controller), the EV charging island system can, when appropriate, (i) cease charging of EVs (thereby preventing any accidental overloading or overcharging of the EVs), (ii) avoid the exposure of live wires (thereby reducing the risk to nearby personnel or equipment), (iii) cease power transfer between the electrical components or other devices included in the EV charging island system (thereby, e.g., preventing damage to batteries included therein), and/or the like.

In some embodiments, the method 1000 continues further by transmitting, in response to receiving the accelerometer signal, an upstream breaker control signal to an upstream breaker selectively coupling the EV charging island system to a power grid. The upstream breaker can be external to (e.g., upstream of) the EV charging island system. The upstream breaker control signal can configure the upstream breaker to cut off power from the power grid to the EV charging island system. By selectively cutting off power to the EV charging island system when the EV charging island system is impacted by an external object (e.g., as determined by the accelerometer and/or the controller), the EV charging island system can, when appropriate, ensure that the system is insulated from the power grid (which is expected to be the greatest source of power for the system) and thereby reduce the risk of continuing power transfer to, e.g., EVs connected to the system or live wires exposed due to the collision. Therefore, in embodiments in which the method 1000 comprises transmitting, in response to receiving the accelerometer signal, both a breaker control signal and an upstream breaker control signal, the system provides a dual-layered safety check to ensure that power is cut off to and within the system.

Referring to FIGS. 1A-10 together, embodiments of the present technology enable several advantages over many existing EV charging infrastructure. First, because most of the system 100 can be manufactured and assembled off-site, installing the system 100 can require significantly less time and labor on-site. Second, because many factors can be more precisely controlled off-site than on-site, prefabrication is also expected to reduce both safety risks and manufacturing errors. Third, because many components of the system 100 can be integrated and assembled together before installation, the system 100 may be UL-listed, thereby reducing the complexities, time, and costs associated with regulatory approval typically required for many existing EV charging infrastructure (e.g., permanently installed charging stations). Fourth, because all of the components can either be mounted on or integrated with the skid 110 having the anchors 120, the system 100 can be both portable and temporary. Fifth, the electrical components 190 included can be customized for specific applications, resulting in a modular EV charging solution. Sixth, because the system 100 itself can include generator sets, batteries, and/or the like, the system 100 can be installed at sites removed from a sufficient utility power supply. Seventh, the system 100 includes an accelerometer-based safety feature that can cut off power at multiple levels (e.g., cut off power to EVs, within the system 100, and to the system 100) upon detecting a collision with an EV or other impact by an external object.

### IV. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. The terms “about,” “approximately,” and “substantially” as used herein shall be interpreted to mean within ±10% of the stated value. Additionally, all ranges disclosed herein are to be understood to encompass the endpoints, and any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. A modular and deployable electric vehicle (EV) charging island system, the system comprising:
a skid including:
a structural frame,
a plurality of anchors coupled to the structural frame and configured to releasably secure the structural frame to a surface, and
an accelerometer mounted on the structural frame;
a plurality of charging posts each mounted on the skid;
a plurality of electrical components each mounted on the skid and electrically coupled to the plurality of charging posts;
a breaker mounted on the skid and operably coupled to at least one of the plurality of electrical components, wherein the breaker is configured to selectively cut off power to and/or from the at least one of the plurality of electrical components; and
a controller operably coupled to the accelerometer and the breaker, wherein the controller is configured to:
receive, from the accelerometer, an accelerometer signal indicating that the skid was impacted by an external object, and
transmit, in response to receiving the accelerometer signal, a breaker control signal to the breaker, wherein the breaker control signal configures the breaker to cut off power to and/or from the at least one of the plurality of electrical components.

2. The system of claim 1, wherein the system is electrically coupled to a power grid via an upstream breaker configured to selectively cut off power from the power grid to the system, and wherein the controller is further configured to transmit, in response to receiving the accelerometer signal, an upstream breaker control signal to the upstream breaker, wherein the upstream breaker control signal configures the upstream breaker to cut off power from the power grid to the system.

3. The system of claim 1, wherein the system is electrically coupled to a power grid, and wherein the plurality of electrical components includes a transformer coupled between the power grid and the plurality of charging posts.

4. The system of claim 1, wherein the system is electrically coupled to a power grid, and wherein the plurality of electrical components includes a generator set and a battery configured to be selectively recharged by the power grid and/or the generator set.

5. The system of claim 1, wherein the plurality of electrical components includes a plurality of batteries configured to be charged by one or more external chargers, wherein the batteries are arranged across the skid to evenly distribute weights thereof.

6. The system of claim 1, further comprising a plurality of a smart posts each mounted on the skid, wherein the skid further includes a plurality of connector plates each configured to be coupled to either a corresponding one of the plurality of smart posts or a lifting lug configured to facilitate handling of the system.

7. The system of claim 1, further comprising:
a plurality of smart posts each mounted on the skid; and
a canopy mounted on the plurality of smart posts and positioned above the plurality of electrical components.

8. The system of claim 7, further comprising:
a plurality of beams each laterally extending between adjacent ones of the plurality of smart posts; and
a plurality of lighting devices mounted on the plurality of beams, wherein each of the plurality of lighting devices is configured to emit light towards an underside of the canopy.

9. The system of claim 7, wherein the canopy is composed of polycarbonate.

10. The system of claim 1, further comprising a plurality of diesel locomotive cables extending from the plurality of electrical components and/or the plurality of charging posts.

11. The system of claim 1, wherein the skid further includes a first cable tray positioned at a first height and a second cable tray positioned at a second height higher than the first height, wherein each of the first cable tray and the second cable tray is configured to support cables extending from the plurality of electrical components and/or the plurality of charging posts.

12. The system of claim 1, wherein the structural frame includes a plurality of steel beams coupled to one another and arranged parallel and/or perpendicular to one another.

13. The system of claim 1, wherein the system has a length between 400-600 inches, a width between 80-120 inches, and a height between 180-250 inches.

14. The system of claim 1, wherein the plurality of charging posts includes:
a first charging post mounted on a first corner of the skid;
a second charging post mounted on a second corner of the skid;
a third charging post mounted on the skid and positioned between the first and second charging posts; and
a fourth charging post mounted on the skid and positioned between the second and third charging posts,
wherein the plurality of electrical components is mounted on a remaining area of the skid.

15. The system of claim 1, wherein the skid, the plurality of charging posts, and the plurality of electrical components are configured to be assembled off-site and transported to an installation site in an assembled state.

16. The system of claim 1, further comprising four smart posts each mounted on the skid, and wherein the plurality of charging posts includes four charging posts each positioned adjacent to a corresponding one of the four smart posts.

17. A method for operating a modular and deployable electric vehicle (EV) charging island system, the method comprising:
receiving an accelerometer signal from an accelerometer of the EV charging island system, wherein the EV charging island system comprises:
a skid including a structural frame, a plurality of anchors configured to releasably secure the structural frame to a surface, and the accelerometer mounted on the structural frame, wherein the accelerometer signal indicates that the skid was impacted by an external object,
a plurality of electrical components each mounted on the skid, and
a breaker mounted on the skid and operably coupled to at least one of the plurality of electrical components, wherein the breaker is configured to selectively cut off power to and/or from the at least one of the plurality of electrical components; and
transmitting, in response to receiving the accelerometer signal, a breaker control signal to the breaker, wherein the breaker control signal configures the breaker to cut off power to and/or from the at least one of the plurality of electrical components.

18. The method of claim 17, further comprising transmitting, in response to receiving the accelerometer signal, an upstream breaker control signal to an upstream breaker selectively coupling the EV charging island system to a power grid, wherein the upstream breaker control signal configures the upstream breaker to cut off power from the power grid to the EV charging island system.

19. The method of claim 17, wherein the accelerometer signal further indicates that an acceleration measured by the accelerometer exceeds a threshold acceleration value.

20. The method of claim 17, wherein receiving the accelerometer signal comprises receiving the accelerometer signal from the accelerometer via a wired connection.
